(19) United States
(12) Patent Application Publication
(10) Pub. No.: US 2026/0347647 A1
(43) Pub. Date: Nov. 5, 2026

(54) EXTRUSION AND CHARACTERIZATION OF COMPOUNDED RECYCLED POLYETHYLENE TEREPHTHALATE (RPET) FILAMENTS FOR MATERIAL-EXTRUSION ADDITIVE MANUFACTURING

(71) Applicant: The Penn State Research Foundation, University Park, PA (US)

(72) Inventors: Ola Hamada Mohamed Rashwan, Middletown, PA (US); Zachary Koroneos, Middletown, PA (US)

(73) Assignee: The Penn State Research Foundation, University Park, PA (US)

(21) Appl. No.: 19/484,749

(22) PCT Filed: May 28, 2024
(86) PCT No.: PCT/US2024/031244

§ 371 Date: Nov. 14, 2025

Related U.S. Application Data
(60) Provisional application No. 63/504,857, filed on May 30, 2023.

(51) Int. Cl. C09D 167/02; B33Y 70/00; C09D 7/61; C09D 7/65; D01F 1/10; D01F 6/62

(52) U.S. Cl. CPC C09D 167/02; B33Y 70/00; C09D 7/61; C09D 7/65; D01F 1/10; D01F 6/62; D10B 2505/00

(57) ABSTRACT

An extrudable filament comprising recycled polyethylene terephthalate (rPET) with low-cost additives, such as at least one chain extender, toughening agent, reactive impact modifier, non-reactive impact modifier, and/or graphite powder is disclosed. Compounding rPET with such additives results in a filament that can be used in MEX-AM technologies and that displays advantageous thermal and mechanical properties. Methods of making the extrudable filament and apparatuses for making the extrudable filament are further disclosed.

### CROSS-REFERENCE TO RELATED APPLICATIONS

The present application claims priority to U.S. Provisional Patent Application No. 63/504,857, filed on May 30, 2023, the entire contents of which is incorporated by reference.

### FIELD OF THE INVENTION

Embodiments relate to compositions comprising recycled polyethylene terephthalate (rPET) and low-cost additives with enhanced thermal and mechanical properties, and methods of making and using thereof.

### BACKGROUND OF THE INVENTION

Polyethylene terephthalate (PET) is one of the most used thermoplastics. PET is a semi-crystalline thermoplastic that belongs to the polyester family; it is recyclable, strong, and lightweight, making it an ideal material in the rigid packaging industry. The global PET market has been exponentially growing in the last few decades. The continuous growth of the annual production and consumption of PET is coined with increasing waste that leaks into the environment, landfills, and oceans as microplastic and nanoplastic fragments. The main concerns of PET products are their short life cycle and high consumption. Recycling PET has been an inevitable mitigation strategy to combat the concerns of PET. Three recycling methods are currently used with PET: mechanical, chemical, and incineration.

The most common method used in recycling PET is mechanical recycling due to its simplicity, low cost, and low energy consumption, which produces less greenhouse gases. However, the major shortcomings of mechanical recycling are thermomechanical and hydrolytic degradation that results from chain scission, molecular weight reduction, and a decrease in intrinsic viscosity.

### SUMMARY

In recent years, researchers have become increasingly interested in the development of new feedstocks for material extrusion additive manufacturing technology (MEX-AM). The global 3D printing filament market generated a revenue of $693.1 million in 2019 and is expected to increase to $7.08 billion by 2030. One approach that takes advantage of the interest in new feedstocks for MEX-AM and resolves the aforementioned shortcomings of mechanical recycling, in general, is to compound recycled PET (rPET) pellets with additives during processing. Compounding virgin and recycled PET with different chain extenders, such as PMDA, has been investigated. In reactive extrusion, PMDA may react with the PET end groups—hydroxyl and carboxylic acid groups—and cause chain extension and branching of PET. Moreover, most PET applications, such as food packaging, strapping, and automotive components, require high-impact resistance. Thus, toughening agents and impact modifiers may be used to improve impact resistance and increase the toughness of virgin PET and rPET.

The development of sustainable rPET filaments to embrace the concept of the circular economy seems to have huge potential in the fast-growing additive technology. According to the United States Environmental Protection Agency's (EPA) definition of circular economy, “a circular economy reduces material use, redesigns materials, products, and services to be less resource intensive, and recaptures ‘waste’ as a resource to manufacture new materials and products.” Recycled polymers and fast-growing MEX-AM technology are anticipated to have tangible impacts on reinforcing the circular economy paradigm. Using rPET filaments to make high-value customized products with longer life cycles using MEX-AM technology can also have profound environmental impacts. To have high-value products from rPET filaments, rPET pellets can be compounded with chain extenders and impact modifiers and extruded into filaments. The mechanical properties of the printed parts are anticipated to improve, and long-term/high-value-added customized products can be made. It is believed that no study has looked specifically at compounding the rPET pellets with additives and extruding them into uniform sustainable filaments for the fast-growing MEX-AM industry.

Accordingly, we worked (i) to evaluate the possibility of extruding rPET pellets compounded with a low-cost chain extender and impact modifiers into printable filaments, and (ii) to evaluate the thermal behavior and the mechanical properties of the compounded filaments and printed samples.

Embodiments relate to compounding rPET with low-cost additives, such as a chain extender, toughening agent, reactive impact modifier, non-reactive impact modifier, and/or graphite powder. Compounding rPET with such additives results in a filament that can be used in MEX-AM technologies while displaying advantageous thermal and mechanical properties.

In an exemplary embodiment, an extrudable filament comprises recycled polyethylene terephthalate and additives, wherein the additives comprise at least one chain extender; at least one toughening agent; at least one reactive impact modifier; and at least one non-reactive impact modifier.

In some embodiments, the filament has a diameter of 1.7-1.8 mm.

In some embodiments, the at least one chain extender is selected from the group consisting of pyromellitic dianhydride, trimellitic anhydride, triphenyl phosphite, multi-functionalized epoxy, and mixtures thereof.

In some embodiments, the at least one chain extender is pyromellitic dianhydride.

In some embodiments, the at least one toughening agent is selected from the group consisting of styrene-ethylene-butylene-styrene terpolymer functionalized with maleic anhydride, polyethylene octene, polyethylene octene grafted with glycidyl methacrylate, and mixtures thereof.

In some embodiments, the at least one toughening agent is styrene-ethylene-butylene-styrene terpolymer functionalized with maleic anhydride.

In some embodiments, the at least one reactive impact modifier is ethylene-ethyl acrylate-glycidyl methacrylate terpolymer or ethylene-vinyl acetate copolymer functionalized with maleic anhydride.

In some embodiments, the at least one non-reactive impact modifier is selected from the group consisting of ethylene-ethyl-acrylate, ethylene-butyl acrylate, ethylene-methyl acrylate, polymethyl methacrylate-g-polybutadiene/styrene graft copolymer, and mixtures thereof.

In some embodiments, the at least one non-reactive impact modifier is ethylene-ethyl-acrylate.

In some embodiments, the filament has a melting temperature of 250-255° C.

In some embodiments, the filament has a degradation onset temperature of 390-410° C.

In some embodiments, the ratio of reactive to non-reactive impact modifier is 30:70.

In an exemplary embodiment, a 3D-printed part made from an extrudable filament comprising recycled polyethylene terephthalate and additives, wherein the additives comprise at least one chain extender; at least one toughening agent; at least one reactive impact modifier; and at least one non-reactive impact modifier.

In some embodiments, the printed part has an elongation percentage ranging from 6% to 100%.

In some embodiments, the printed part has a tensile strength ranging from 35 MPa to 48 MPa.

In some embodiments, the printed part has a flexural strength ranging from 35 MPa to 46 MPa.

In some embodiments, the printed part has a 30% flexural strain at break.

In some embodiments, the printed part has an impact energy of about 2.5 KJ/m².

In an exemplary embodiment, an extrudable filament comprises recycled polyethylene terephthalate and additives, wherein the additives comprise at least one chain extender; at least one toughening agent; and graphite powder.

In some embodiments, the additives further comprise at least one reactive impact modifier and at least one non-reactive impact modifier.

In some embodiments, the graphite powder is present in an amount between 5-15 wt % of the filament.

In an exemplary embodiment, a method of forming the extrudable filament as described above comprises drying the recycled polyethylene terephthalate and additives, mixing the recycled polyethylene terephthalate and additives to form a compounded blend; extruding the compounded blend to form an extruded filament; and cooling the filament.

In some embodiments, cooling the filament comprises air cooling or water cooling.

### BRIEF DESCRIPTION OF THE DRAWINGS

The above and other objects, aspects, features, advantages and possible applications of embodiments of the present innovation will be more apparent from the following more particular description thereof, presented in conjunction with the following drawings. Like reference numbers used in the drawings may identify like components.

FIG. 1 shows a flow chart illustrating an exemplary method for forming an extrudable filament.

FIG. 2 shows an exemplary extruded filament spool for a MEX-AM process.

FIG. 3 is a graph showing the melt flow index of exemplary rPET, rPET/PMDA and rPET/IMs filaments.

FIG. 4A is a graph showing representative differential scanning calorimetry curves for exemplary rPET, rPET/PMDA, and rPET/IMs filaments. The first heating cycle shows the recrystallization temperatures (Tcc) and the melting peaks.

FIG. 4B is a graph showing representative differential scanning calorimetry curves for exemplary rPET, rPET/PMDA, and rPET/IMs filaments. The cooling cycle shows the crystallization peaks.

FIG. 4C is a graph showing representative differential scanning calorimetry curves for exemplary rPET, rPET/PMDA, and rPET/IMs filaments. The second heating cycle shows the glass transition temperatures (T_{g}) and the melting temperature (Tₘ) after removing the thermal history.

FIG. 5A is a graph showing representative differential scanning calorimetry curves for exemplary rPET, rPET/PMDA, and rPET/IMs printed samples. The first heating cycle shows the recrystallization temperatures (Tcc) and the melting peaks.

FIG. 5B is a graph showing representative differential scanning calorimetry curves for exemplary rPET, rPET/PMDA, and rPET/IMs printed samples. The cooling cycle shows the crystallization peaks.

FIG. 5C is a graph showing representative differential scanning calorimetry curves for exemplary rPET, rPET/PMDA, and rPET/IMs printed samples. The second heating cycle shows the glass transition temperatures (T_{g}) and the melting temperature (Tₘ) after removing the thermal history.

FIG. 6 is a graph showing TGA curves for exemplary filaments made of rPET, rPET/PMDA and rPET/IMs.

FIG. 7 is a graph showing TGA curves for exemplary printed rPET, rPET/PMDA and rPET/IMs.

FIG. 8 is a graph showing representative tensile stress-strain curves for exemplary printed rPET, rPET/PMDA, and rPET/IMs.

FIG. 9A is a graph showing average tensile strengths for exemplary printed rPET, rPET/PMDA, and rPET/IMs.

FIG. 9B is a graph showing average elastic moduli for exemplary printed rPET, rPET/PMDA, and rPET/IMs.

FIG. 10A is a graph showing representative flexural stress-strain curves for exemplary printed rPET, rPET/PMDA, and rPET/IMs.

FIG. 10B is a graph showing average flexural strengths for exemplary printed rPET, rPET/PMDA, and rPET/IMs.

FIG. 11 is a graph showing IZOD tests for exemplary printed rPET, rPET/PMDA, and rPET/IMs.

FIG. 12A is an electron micrograph of fractured surfaces of an exemplary rPET filament.

FIG. 12B is an electron micrograph of fractured surfaces of exemplary rPET/PMDA filament.

FIG. 12C is an electron micrograph of fractured surfaces of exemplary rPET/IMs filament.

FIG. 12D is a high-magnification micrograph of exemplary rPET/IMs filament.

FIG. 13A shows an exemplary twin-screw extruder for forming an extrudable filament.

FIG. 13B shows the production of three strands simultaneously via three output holes of a die of a twin-screw extruder.

FIG. 13C shows an exemplary water-cooling path for forming an extrudable filament.

FIG. 14 is a graph showing representative differential scanning calorimetry curves for exemplary rPET and rPET/graphite printed samples.

FIG. 15 is a graph showing TGA curves for exemplary filaments made of rPET and rPET/graphite.

FIGS. 16A-16C are electron micrographs of fractured surfaces of an exemplary rPET/graphite filament.

### DETAILED DESCRIPTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

Embodiments relate to an extrudable filament comprising recycled polyethylene terephthalate (rPET) and additives. The additives include at least one chain extender, at least one toughening agent, at least one reactive impact modifier, at least one non-reactive impact modifier, and/or graphite powder.

In exemplary embodiments, the chain extender may be pyromellitic dianhydride (PMDA), trimellitic anhydride (TMA), triphenyl phosphite (TTP), multi-functionalized epoxy (e.g., Joncryl®), and/or mixtures thereof. In other embodiments, the chain extender can include PMDA, TMA, TTP, multi-functionalized epoxy, and/or mixtures thereof. It is contemplated that the chain extender may be present in the filament in an amount ranging from 0.05 to 2.0 wt %. In embodiments wherein the chain extender includes PMDA, the PMDA may be present in the filament at 0.3 wt %. In embodiments wherein the chain extender includes TMA, the TMA may be present in the filament in an amount ranging from 0.01 to 1.5 wt %, preferably 0.4 to 0.6 wt %. In embodiments wherein the chain extender includes TPP, the TPP may be present in the filament in an amount ranging from 0.2 to 0.8 wt %. In embodiments wherein the chain extender includes multi-functionalized epoxy, the multi-functionalized epoxy may be present in the filament at 1.0 wt %.

In exemplary embodiments, the toughening agent may be styrene-ethylene-butylene-styrene terpolymer functionalized with maleic anhydride (SEBS-g-MA), polyethylene octene (POE), polyethylene octene grafted with glycidyl methacrylate (POE-g-GMA), and/or mixtures thereof. In other embodiments, the toughening agent can include SEBS-g-MA, POE, POE-g-GMA, and/or mixtures thereof. It is contemplated that the toughening agent may be present in the filament in an amount ranging from 1.0 to 5.0 wt %.

In exemplary embodiments, the reactive impact modifier may be ethylene-ethyl acrylate-glycidyl methacrylate terpolymer (E-EA-GMA), ethylene-vinyl acetate copolymer functionalized with maleic anhydride (E-VA-MA), or mixtures thereof. In other embodiments, the reactive impact modifier can include E-EA-GMA, E-VA-GMA, or mixtures thereof. It is contemplated that the reactive impact modifier may be present in the filament in an amount ranging from 1.5 to 10 wt %. In embodiments wherein the reactive impact modifier includes E-EA-GMA, it is contemplated that the component ratio is 68:24:8, respectively.

In exemplary embodiments, the non-reactive impact modifier may be ethylene-ethyl-acrylate (EEA), ethylene-butyl acrylate copolymer (EBA), ethylene-methyl acrylate copolymer (EMA), and polymethyl methacrylate-g-polybutadiene/styrene graft copolymer (MBS), or mixtures thereof. In other embodiments, the non-reactive impact modifier can include EEA, EBA, EMA, MBS, or mixtures thereof. It is contemplated that the non-reactive impact modifier may be present in the filament in an amount ranging from 3.6 to 24 wt %.

It is contemplated that the ratio of a reactive impact modifier to a non-reactive impact modifier in the filament may be 30:70.

In exemplary embodiments, the graphite powder (e.g., in particulate form) may be present in the filament in an amount ranging from 5.0 to 15.0 wt %, preferably at 15.0 wt %. It is contemplated that the graphite powder may be configured to increase the thermal stability, stiffness, impact resistance, and conductivity of the filament. The graphite powder may have a carbon content of 95% or greater and may further have a moisture content of 5% or less.

It is contemplated that the filament may have a diameter of 1.75±0.05 mm.

The above-described extrudable filament may be used in 3D-printing technology to form a printed part. It is contemplated that a printed part may have elongation percentage ranging from 5% to greater than 100%, a tensile strength ranging from 33 MPa to 48 MPa, a flexural strength ranging from 35 MPa to 46 MPA, a flexural strain at break ranging from 6% to 30%, an impact energy ranging from 1 kJ/m² to 2.5 KJ/m², an onset degradation temperature of 390-410° C., and an average melting temperature of 250-255° C.

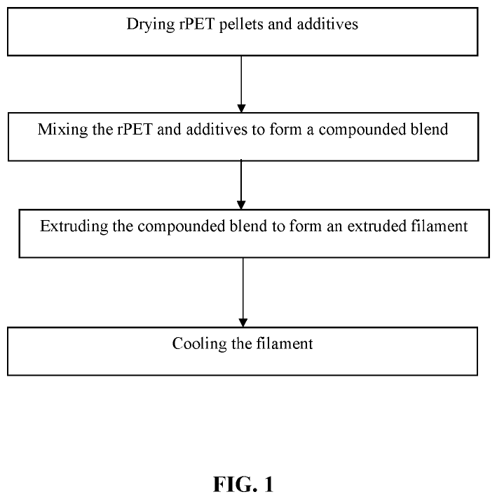

Referring to FIG. 1, a method of forming the extrudable filament comprises drying the rPET and the additives, and then subsequently mixing the rPET with the additives to form a compounded blend. The rPET may be in pellet form. The rPET and additives may be mixed using any suitable means. The compounded blend may then be extruded to form an extruded filament. The compounded blend may be extruded using any suitable means, such as a twin screw extruder. It is contemplated that drying the rPET and the additives prior to extrusion is crucial to prevent the hydrolysis degradation during the reactive extrusion process. It is further contemplated that prospering cooling rate is crucial in controlling the filament's dimensional accuracy, mechanical properties, and flexibility.

The extruded filament may then undergo one or more post-extrusion steps. In one embodiment, the extruded filament may be cooled. Cooling may be carried our using any suitable means, such as water, air or any other suitable media.

It is contemplated that the extruded filament may be used in additive manufacturing technology processes.

### EXAMPLES

Example 1. This example investigates the effect of a chain extender (e.g., PMDA) and impact modifiers on the extrusion, thermal behavior, and mechanical properties of a rPET extrudable 3D printing filament.

### Materials

Mechanically recycled PET (rPET) pellets were acquired from Cougle's Recycling Inc. in Pennsylvania, USA, through the Recycling Markets Center at Pennsylvania State University at Harrisburg. The following four additives were acquired for compounding with rPET: (1) Pyromellitic dianhydride (PMDA), a chain extender (Sigma Aldrich), (2) Styrene-ethylene-butylene-styrene terpolymer functionalized with maleic anhydride (SEBS-g-MA), a thermal modifier and toughening agent (FG1901X, KRATON Polymers), (3) Ethylene-ethyl acrylate-glycidyl methacrylate terpolymer (E-EA-GMA), a functional reactive elastomeric impact modifier (Lotader AX 8900, Palmer Holland), and (4) Ethylene-ethyl-acrylate (EEA), a non-reactive elastomeric impact modifier (Sigma Aldrich).

The first compounded rPET blend consists of rPET and PMDA (rPET/PMDA). A 0.3 wt. % of PMDA was bag mixed with rPET pellets for 3 minutes and poured into the feeder. This first compound is referred to as “rPET/PMDA” in this example. The second compound contains a blend of 0.3 wt. % PMDA, 5.0 wt. % SEBS-g-MA, 1.5 wt. % E-EA-GMA, and 3.6 wt % of EEA. The 30:70 ratio of functional reactive and non-reactive impact modifiers, E-EA-GMA and EEA, may ensure uniform dispersion of the rubber additive into the rPET matrix. The second blend is labeled as “rPET/IMs” in this example. The rPET pellets were dried at 120° C. for 12 hours in a vacuum dryer (Macguire). The four other additives (PMDA, SEBS, E-EA-GMA, EEA) were dried in separate vacuum dryers (Thermo Precision Scientific) for four hours at 50° C. and kept in a vacuum dryer until extrusion.

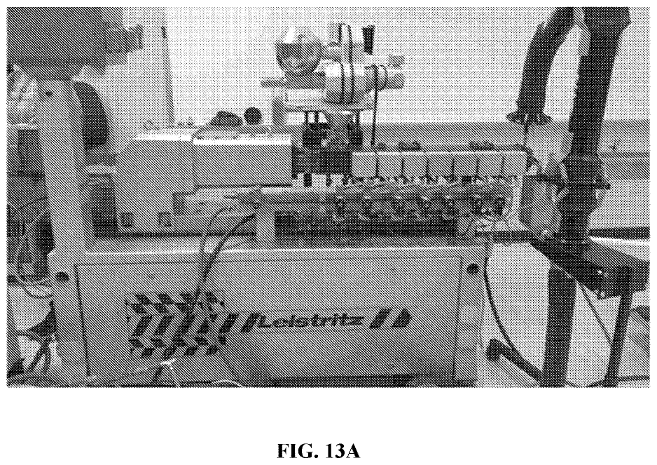

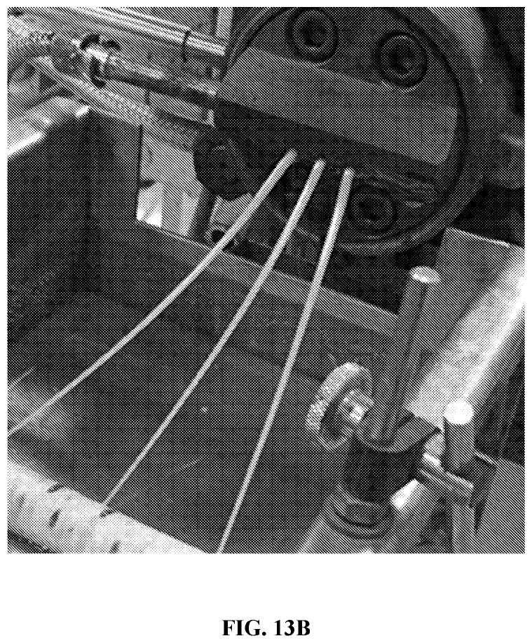

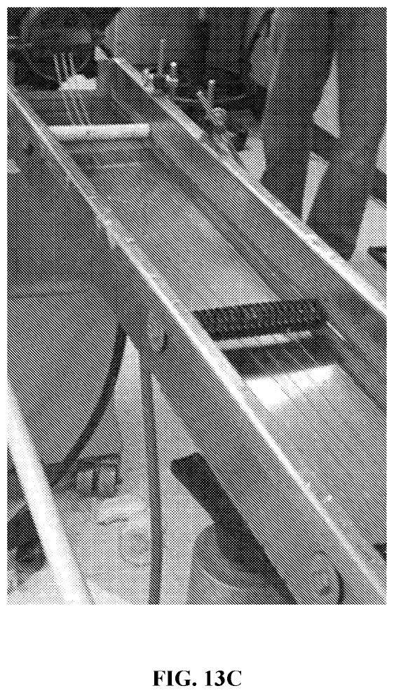

A twin-screw co-rotating extruder (Leistritz) is shown in FIG. 13A. First, the dried rPET pellets and additives were bag-mixed for 3 minutes; then, each compounded rPET blend was starve-fed using a volumetric feeder into the hopper of the twin-screw extruder. The throughput of the volumetric feeder was 10.4 kg/hr. The speed of the screws was set at 150±3 rpm throughout all extrusion processes. The extruder has eight individually-controlled temperature zones. The zone temperatures for each compound; (1) rPET, (2) rPET/PMDA and (3) rPET/IMs are listed in Table 1. The extrusion of rPET/PMDA and rPET/IMs had temperature zones increased to 280° C. to reach the reaction temperature between rPET with the additives. The die of the twin-screw extruder has three output holes, producing three strands simultaneously as shown in FIG. 13B. The filament was water-cooled in a water bath. Within the water bath, cylindrical metal pieces were used to maintain a straight path toward the filament puller as depicted in FIG. 13C. The filament was fed into the filament puller which was adjusted based on the diameter measurements using a digital micrometer. The filament puller speed was set at 0.36 m/s, 0.31 m/s, and 0.28 m/s for the rPET, rPET/PMDA, and rPET/IMs, respectively. The filament diameter was measured on two axes: parallel and perpendicular to the force of the puller. Once the diameter was within 1.75±0.05 mm, the filament were spooled on a mechanical spooler.

TABLE 1
Temperatures of the Eight Extrusion Zones of the
Plain and Compounded rPET

| | Zone Temperatures (° C.) | | | | | | | |
|---|---|---|---|---|---|---|---|---|
| Compound | 1 | 2 | 3 | 4 | 5 | 6 | 7 | 8 |
| rPET | 220 | 220 | 240 | 240 | 250 | 250 | 250 | 260 |
| rPET/PMDA | 220 | 230 | 250 | 260 | 260 | 275 | 280 | 280 |
| rPET/IMs | 220 | 230 | 250 | 260 | 260 | 275 | 280 | 280 |

The ASTM standards' specimens for tensile, 3-point flexural, and IZOD impact tests were printed. The filaments were dried at a temperature of 65° C. for 2-3 hours before printing. The filament is then stored in a dehumidifier to mitigate the hygroscopicity of rPET. The Ultimaker Cura 5.0 slicing software was used to generate the process parameters for an Ender 5 Pro 3D Printer (CREALITY). The ironing feature was activated, and no support has been used. The printing parameters are tabulated in Table 2.

The printing parameters were optimized to maximize dimensional accuracy. This includes the nozzle temperature, layer height, printing speed, and printing bed temperature to avoid shrinkage during printing. The printing parameters were the same for the compounded and plain rPET samples. The average dimensional accuracy was ±1.5%.

TABLE 2
Material Extrusion-based Additive Manufacturing Parameters

| Nozzle Temperature | 260 | °C | Printing Bed | 90 | °C |
|---|---|---|---|---|---|
| | | | Temperature | | |
| Infill Density | 100% | | Infill Pattern | Rectilinear/Lines | |
| Printing Speed | 50 | mm/s | Wall Thickness | 1 | mm |
| Raster Angle | 45/−45° or 0° | | Nozzle Type | 0.4 mm Hardened | |
| | | | | Steel | |
| Layer Thickness | 0.2 | mm | Top/Bottom | 0.8 | mm |
| | | | Thickness | | |

Rheological, thermal, mechanical, and morphological characterizations were carried out to analyze the additives' effect on the behavior of the filaments and printed parts.

Rheological Characterization: The melt flow index was measured using Dynisco melt flow indexer according to ASMT D1238: a six-minute hold and a ten-second cut at 270° C./2.16 Kg were maintained with all samples. The test was done in triplets, and the average melt flow index (MFI) was calculated for each blend.

Thermal Characterization: Small pieces (approximately 5 mg) were cut from the filaments and the 3D-printed tensile specimens for the thermogravimetric analysis (TGA) and differential scanning calorimetry (DSC). The TGA tests were conducted on a SDT Q600-TA Instruments. All samples were heated up from 25° C. to 800° C. at 20° C./min under a nitrogen atmosphere.

The DSC tests were performed on TA Instrument Q2000 following the ASTM D3418 standard. First, the samples were heated from room temperature to 320° C., then cooled to −50° C., then heated again to 300° C., and finally cooled to room temperature. All heating/cooling rates were 20° C./min under a nitrogen flow of 50 ml/min. The second heating cycle was performed to remove the thermal history of the specimens. The data were processed using Universal analysis (UA)-TA Instruments software. The crystallinity was calculated using the following equation:

$$\% Crytallinity = \frac{Δ {H}_{m} - Δ {H}_{cc}}{Δ {H}_{f}} \times 100$$

Where ΔHₘ is the area under the melting endotherm and ΔH_{cc} is the area under the exotherm cold recrystallization peak from the first heating cycle, and ΔH_{f} is the heat of fusion of a 100% crystalline PET of 140 J/g.

Mechanical Testing: The uniaxial tensile and 3-point flexural tests were conducted using MTS Insight 30 load frame with a 5 kN load cell using the standard tensile wedges and the 3-point bending fixtures. The tensile tests were performed according to ASTM D638 on type V printed specimens and a constant displacement rate of 2 mm/min. The ultimate tensile strength and the modulus of elasticity were measured. The 3-point flexural tests were carried out according to ASTM D790. The samples were printed with a width of 12.7 mm, a thickness of 3.2 mm and a support span was 50 mm. The displacement rate was set to 2 mm/min. The flexural strength and the strain at break were measured. A minimum of five samples were tested for each test. IZOD impacts tests were carried out according to the ASTM 256-10 (2018) standard using TMI (Testing Machines Inc.) impact tester. The notched samples have a square cross-section of 12.7±0.2 mm, a length of 63.5±2 mm, and a notch depth of 2.0 mm. The samples were tested in triplicate.

Fracture Analysis: Fractured surfaces from the failed tensile and IZOD impact samples were air-dried and sputter coated with a gold-palladium target under Argon atmosphere for approximately three minutes with a sputtering current of 30 mA. Sample fracture surfaces were then examined by scanning electron microscopy using a Quanta 200 by FEI. All micrographs were captured as secondary electron (SE) images using an Everhart-Thornley detector with an acceleration voltage of 5 kV.

### Results

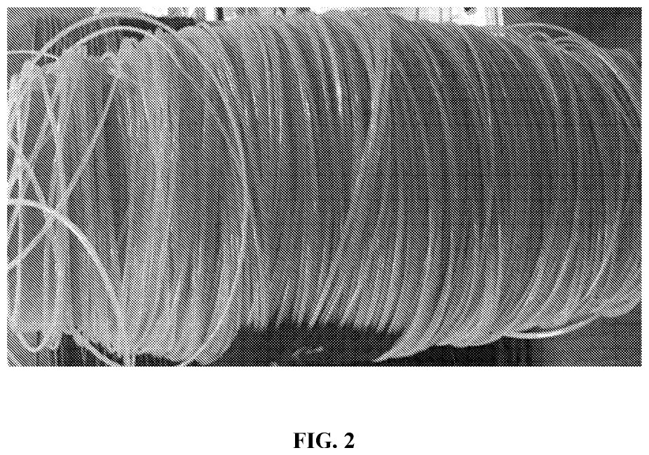

Extrusion of plain rPET and compounded rPET filament of 1.75±0.05 mm was performed on the twin-screw extruder. Filament of uniform diameters was obtained (see FIG. 2), and the pulling speed was adjusted to obtain the required filament diameter. The extrusion parameters were adjusted to obtain filaments that are flexible and processable during MEX-AM. Drying the pellets before extrusion and water cooling of the extruded filament were two crucial parameters to control the dimensional accuracy and flexibility of the filament.

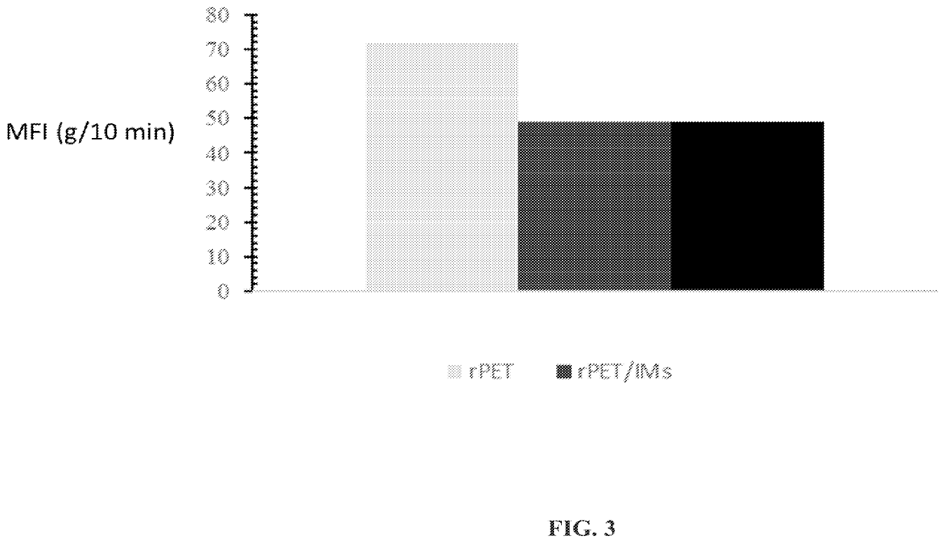

Rheological Behavior: As shown in FIG. 3, the additives may improve the melt flow index (MFI) of rPET in general. The addition of the chain extender by itself or with the impact modifiers may result in a similar MFI of 49.1 g/10 min. This may be attributed to the increase of the molar mass due to the compounded additives. The addition of the PMDA may decrease the melt flow index which may infer the increase of intrinsic viscosity and the melt strength. This, in turn, may make rPET allowed to be foamed and suitable for the multiple extrusion cycles without degradation.

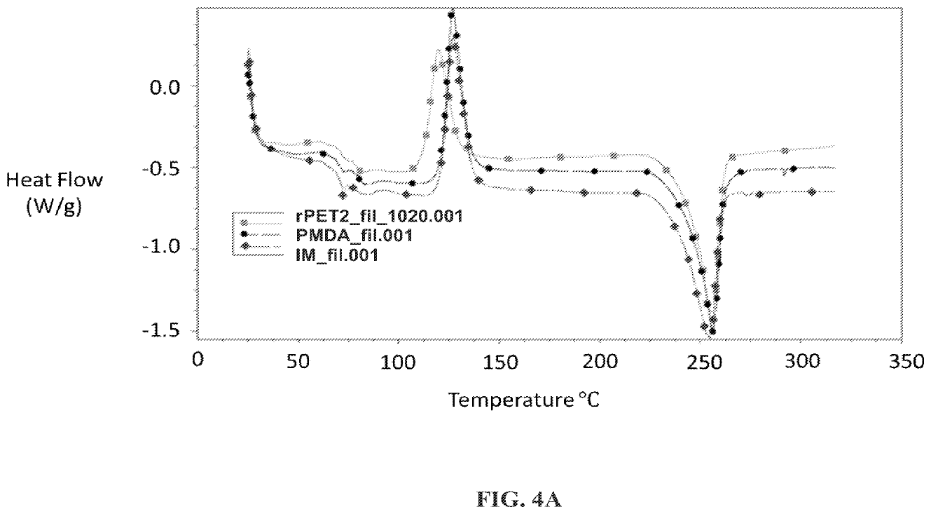

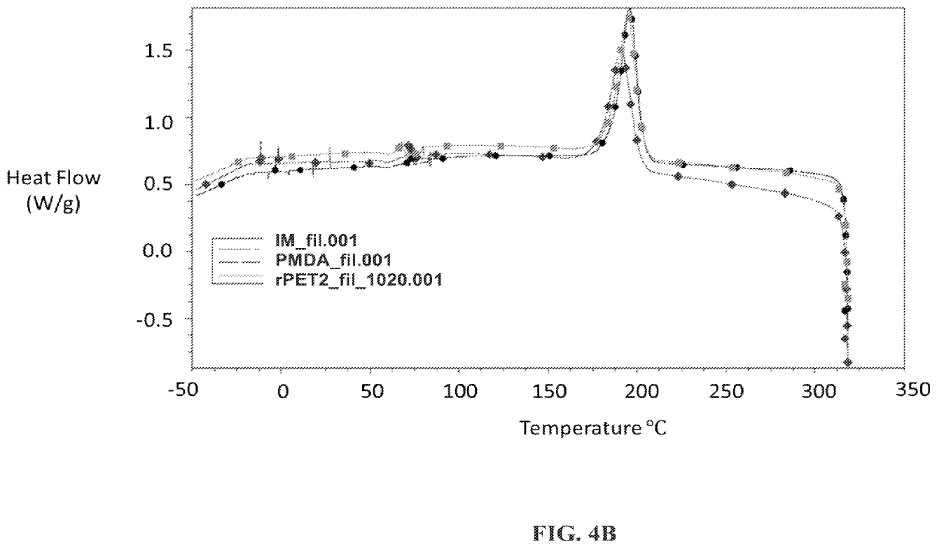

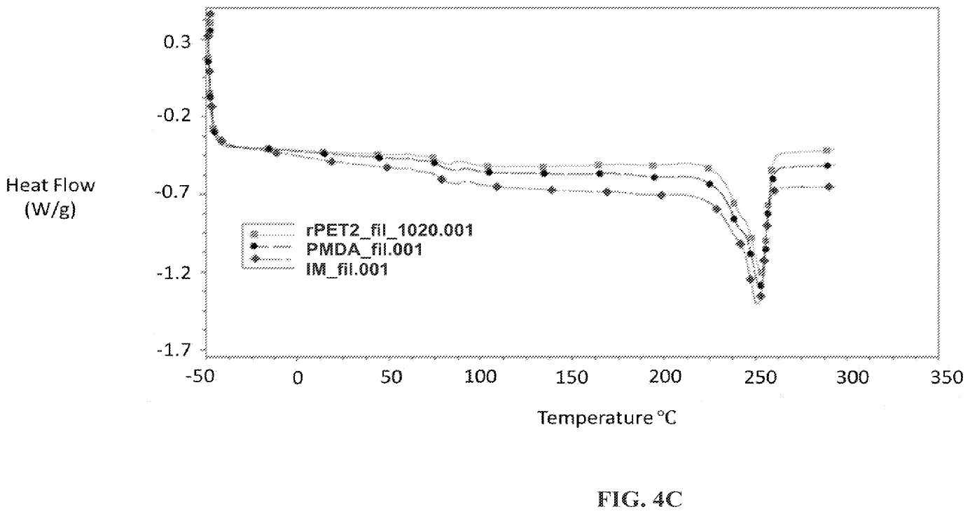

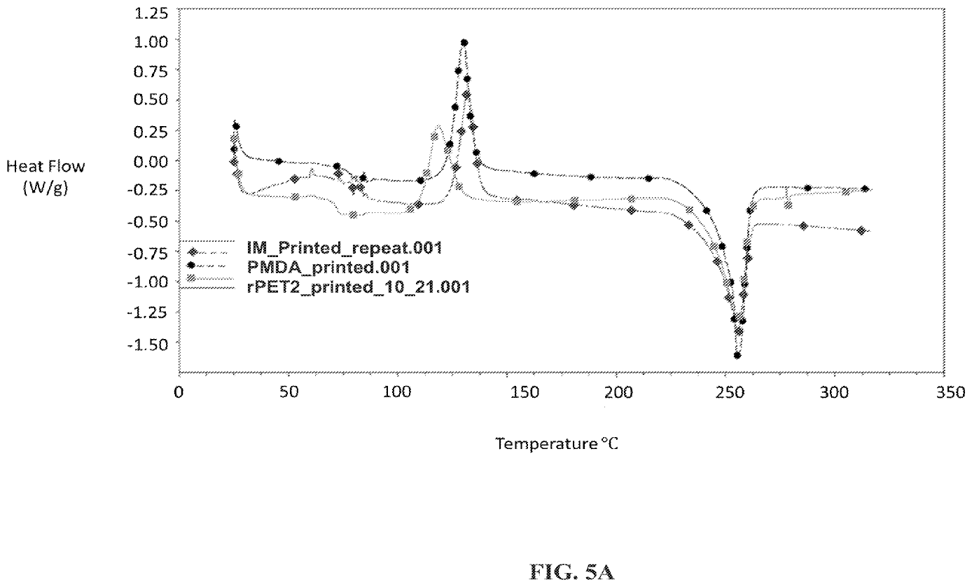

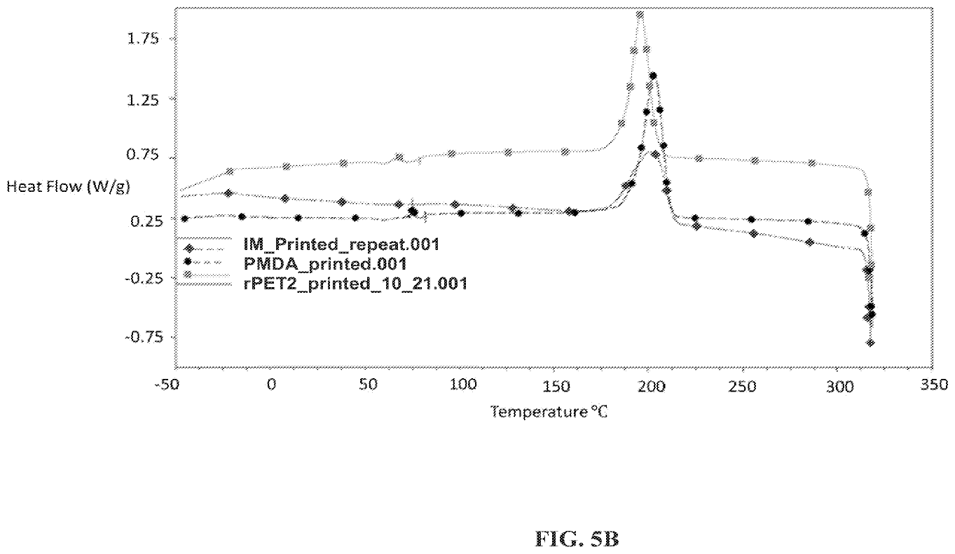

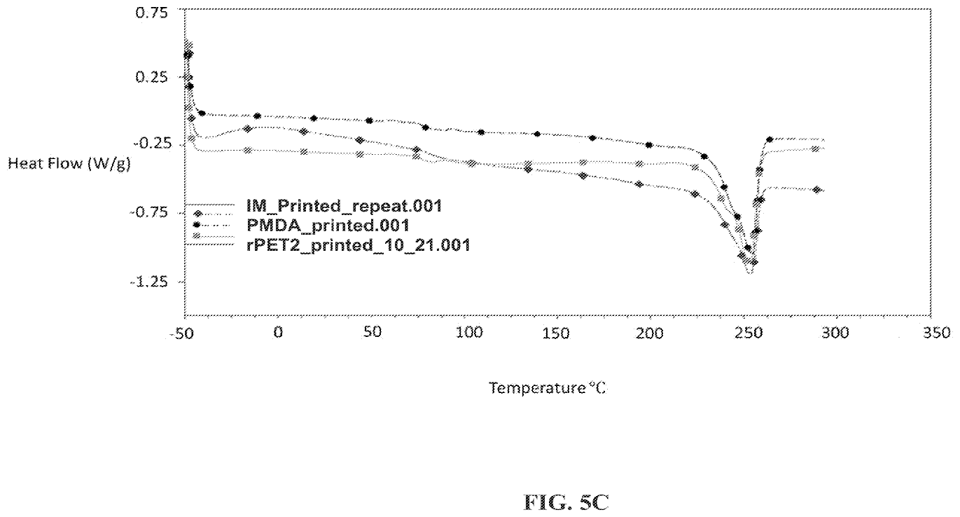

Thermal Analysis: The thermal behavior of the plain rPET and compounded rPET filaments and printed parts has been studied to evaluate the effect of the additives on the glass transition temperature (T_{g}), the melting temperature (Tₘ), the crystallinity (% X_{c}) and the thermal stability. The heating and cooling curves resulting from the DSC are depicted in FIGS. 4A-C and 5A-C, and Table 3 summarizes the thermal characteristics of the plain and compounded rPETs.

The first heating curves show the recrystallization peaks of the amorphous part of the samples and melting peaks, whereas the cooling curves show the crystallization peaks/temperatures. The curves of the second heating cycles show the glass transition temperatures and the effect of the multiple heating on the melting temperatures.

The recrystallization peaks/temperatures of the compounded rPET filaments shifted to higher temperatures due to the additives restrain, and the peaks are larger than the plain rPET, indicating a higher amount of the amorphous character. Similar behavior showed up in the thermograms of the 3D printed parts; the peak of the rPET/IMs shifted to a slightly higher temperature than rPET/PMDA but the peak of rPET/PMDA is the largest.

The crystallization peaks of the rPET/IMs filament and printed sample were smaller and more broadened than those for rPET and rPET/PMDA samples and shifted to a lower temperature, indicating a decrease in enthalpy of crystallization and less crystallinity. This is likely due to the rubbery nature of the impact modifiers.

The additives may slightly impact the glass transition temperatures for filaments and printed samples. The printed samples may have higher average glass transition temperatures than the filament. Therefore, slight adjustments to the processing temperatures of the compounded PET may be needed.

The effect of the additives on the melting temperatures may not be pronounced. The melting temperatures of all formulations centered around 255° C.±1° C. and at a slightly lower temperature of 252° C.±2° C. for the second heating cycle, which reveals the thermal stabilities of the compounded rPETs even after frequent melting cycles during processing and testing.

For the first heating cycles, the melting peaks were single and narrow, implying homogeneity of the rPET matrix with the additives and the uniformity of the crystallites' sizes.

The crystallinity of the water-cooled plain rPET filament was the highest compared to the compounded filaments. The compounded filaments had a similar crystallinity degree. The structural disorder and the entanglements of the branched chains induced by the chain extender and the impact modifiers decreased the molecular mobility and the diffusion into the nucleation sites resulting in small crystallites and low crystallinity. For the MEX-AM technology, an increase in crystallinity tends to increase the material's strength and stiffness but reduces its ductility. So, the crystallinity can be optimized so that the filament is strong but flexible enough not to break during printing which has been achieved in this project.

The printed samples had higher crystallinity than the filaments. The higher crystallinity of the printed samples might be attributed to the printing conditions that include a slow cooling rate, a high printing bed temperature, and a slow printing speed.

TABLE 3
Thermal Properties of the Plain and
Compounded rPET Filaments

| | T_{g} | T_{cc} | T_{m, 1} | T_{m, 2} | T_{c} | ΔH_{cc} | | |
|---|---|---|---|---|---|---|---|---|
| | [° C.] | [° C.] | [° C.] | [° C.] | [° C.] | [J/g] | ΔHₘ | %X_{c} |
| rPET- | 77.3 | 120.0 | 255.8 | 253.6 | 194.6 | 25.3 | 41.6 | 11.6 |
| filament | | | | | | | | |
| rPET/ | 79.9 | 126.8 | 255.8 | 252.8 | 195.7 | 29.0 | 41.2 | 8.7 |
| PMDA- | | | | | | | | |
| filament | | | | | | | | |
| rPET/ | 77.4 | 127.0 | 254.8 | 251.2 | 190.7 | 27.9 | 40.3 | 8.8 |
| IM-filament | | | | | | | | |
| rPET-3D | 79.5 | 118.8 | 255.6 | 252.6 | 196.1 | 23.3 | 42.3 | 13.6 |
| printed | | | | | | | | |
| rPET/ | 83.3 | 130.0 | 255.4 | 254.8 | 203.4 | 26.7 | 46.6 | 14.2 |
| PMDA-3D | | | | | | | | |
| printed | | | | | | | | |
| rPET/ | 81.3 | 132.2 | 255.9 | 253.5 | 202.3 | 23.0 | 36.1 | 9.3 |
| IM-3D | | | | | | | | |
| printed | | | | | | | | |

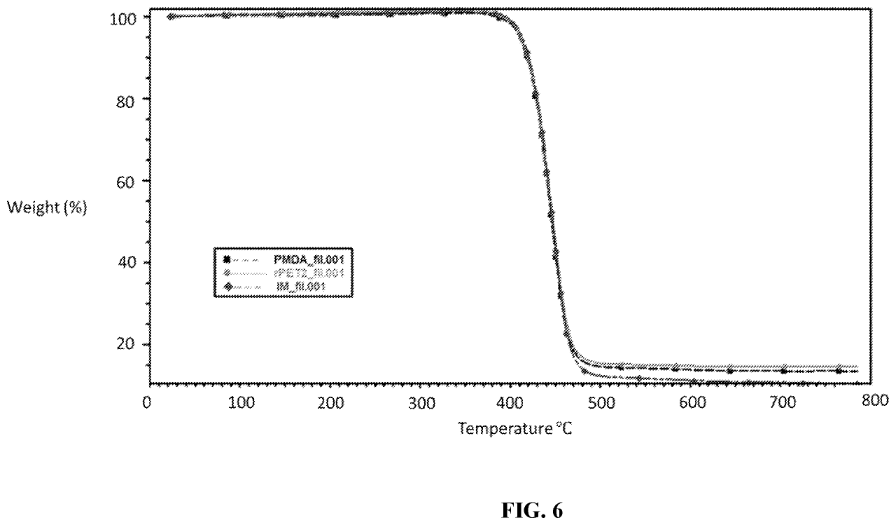

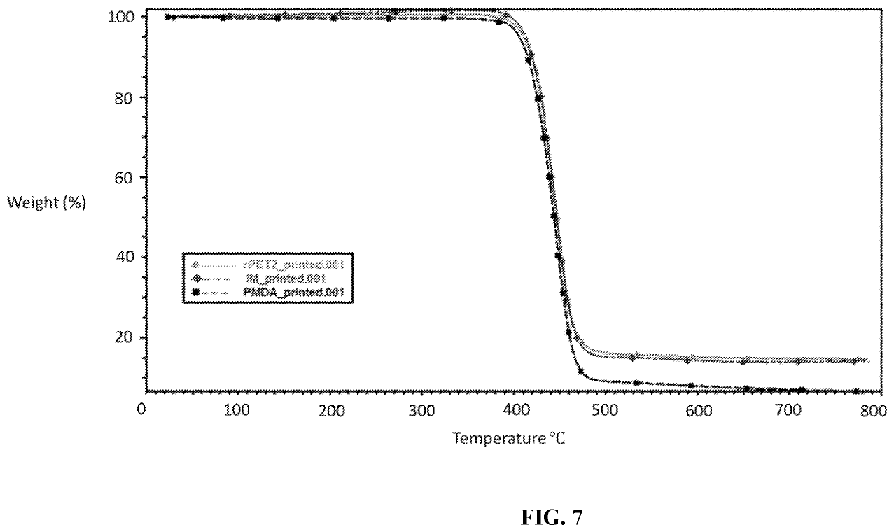

As seen in FIGS. 6-7, only one degradation peak around 410° C. for the filaments and printed samples is shown, indicating that the additives did not influence the decomposition temperatures, especially for rPET/IMs compound that has high elastomeric contents. The single degradation peak also implies the homogeneity of the compounded rPETs. Furthermore, the onset degradation temperature of 410° C. guarantees that the rPET blends would not degrade during the extrusion temperature of 280° C. or the printing temperature of 260° C.

Mechanical Properties: Uniaxial tensile test, 3-point flexural test, and Izod impact tests were carried out to reveal the effect of the additives on the mechanical properties. Tensile strength, modulus of elasticity, flexural strength, % strain at the break, and impact energy of plain rPET and compounded rPET were estimated for the printed samples.

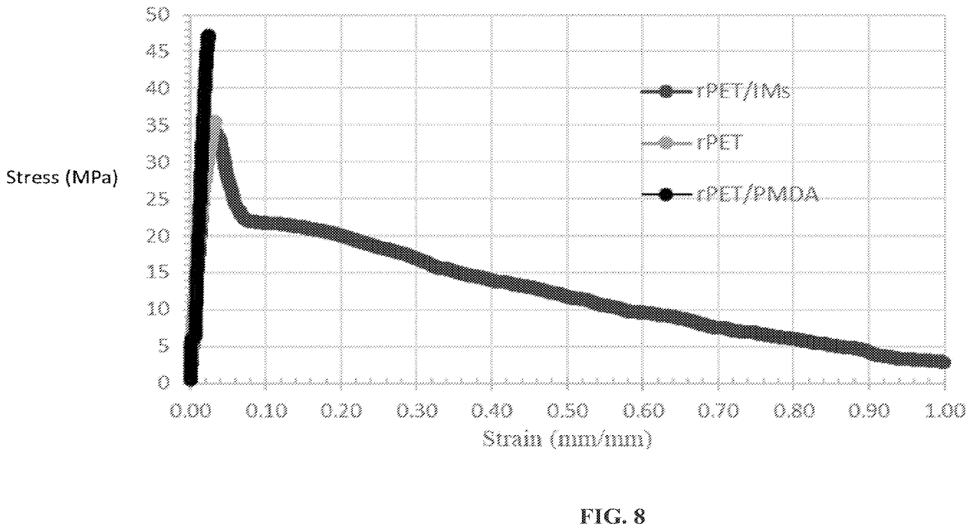

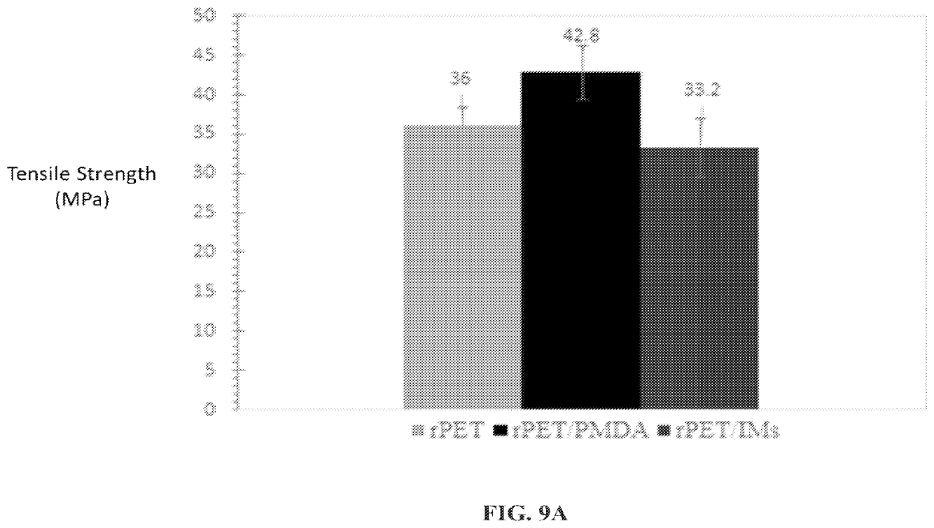

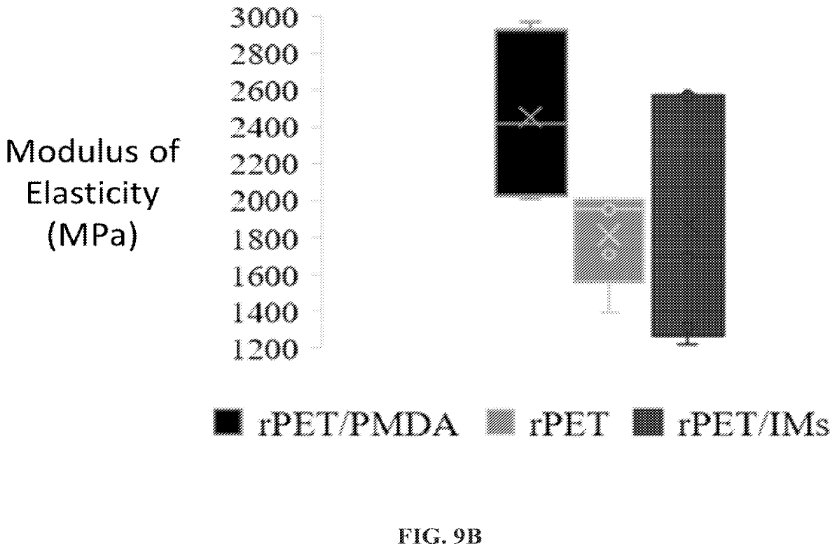

FIG. 8 displays the representative tensile stress-strain curves and FIGS. 9A-B are graphic summaries of the average tensile strengths and moduli of elasticity of the printed samples of plain rPET, rPET/PMDA, and rPET/IMs. These figures revealed the positive impact of the additives on the strength, strain, and stiffness. Compared to the plain rPET, the rPET/IMs had a slight lower average tensile strength and modulus of elasticity (approximately 6%); on the other hand, the rPET/PMDA showed an average increase of 25% in tensile strength and 30% increase in the elastic modulus. For the % elongation, as it was anticipated, the rPET/IMs showed the highest % elongation with an average of more than 100%, while the % elongation of the plain rPET and rPET/PMDA ranges from 3% to 6%.

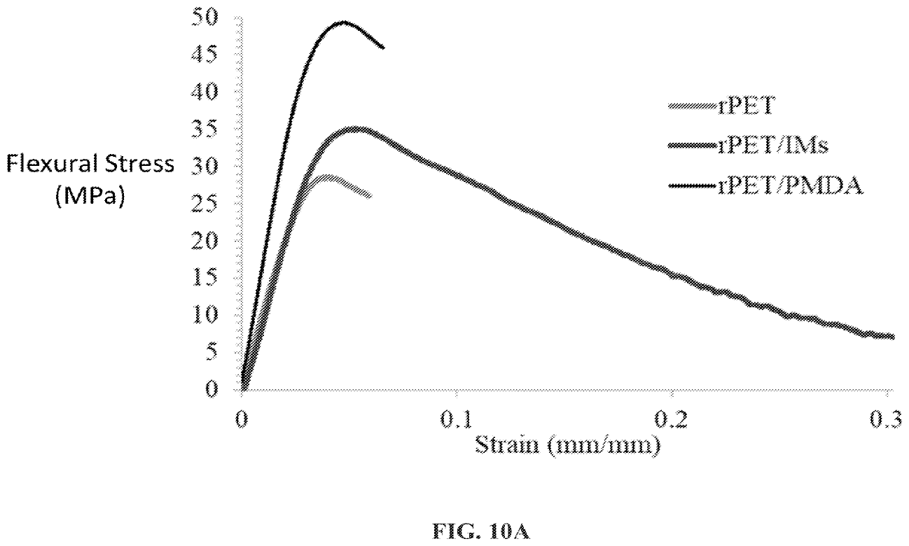

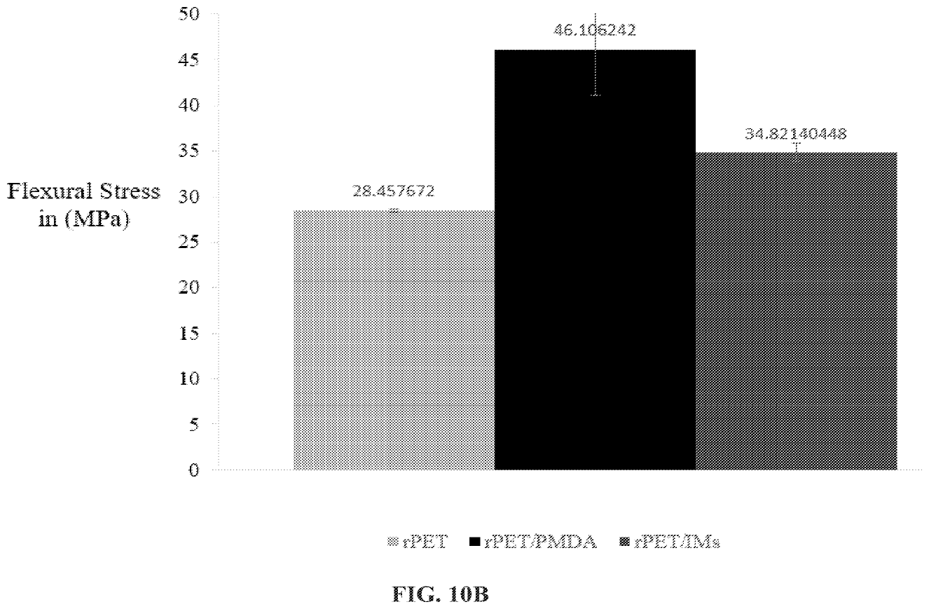

The three-point flexural tests were performed on the 3D printed samples according to ASTM D966 using MTS Insight 30 load frame with a 5 kN load cell with the 3-point bending fixtures. FIGS. 10A and 10B showed the representative flexural stress-strain curves and the average and dispersion of the flexural strength for rPET, rPET/PMDA and rPET/IMs printed standard samples. The rPET/PMDA printed samples recorded the highest average flexural strength of 46 MPa, then rPET/IMs recorded 35 MPa and the plain rPET recorded 30 MPa. The rPET/IMs had the highest % strain at break of 30%, then plain rPET and PET/PMDA at 6% elongation. This behavior is very similar to the tensile loading behavior.

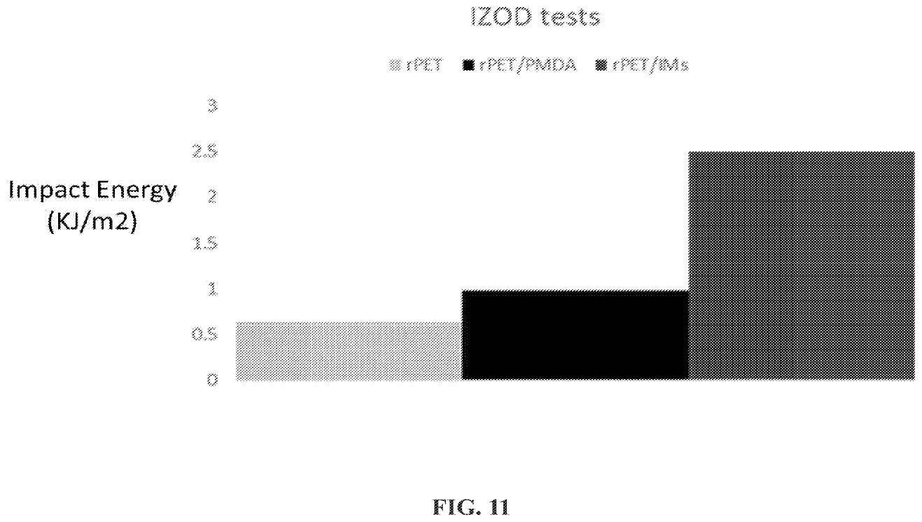

IZOD Impact Tests: The IZOD impact samples were tested according to the ASTM D256. FIG. 11 shows that the compounded rPET/IMs printed samples have the highest impact energy. This enhancement in the impact energy indicates the well dispersed phase of the reactive and non-reactive rubbery additives by grafting to the rPET matrix. The addition of the functionalized SEBS and lotader would prevent coalescence of the particles and ensure proper interfacial adhesion of the rubbery additives into the matrix and forms small uniform elastomeric well dispersed phase. Fractured surfaces of the rPET/IMs also confirmed the well-dispersed phase of the reactive, non-reactive impact modifiers and SEBS within the rPET matrix.

The average modulus of elasticity of rPET/PMDA increased substantially compared to the plain rPET. The branched structure is generated from the reactions between the end hydroxyl group of rPET and the PMDA. The branched and entangled chains are anticipated to increase the stiffness of the compounded rPET/PMDA.

A positive correlation between the crystallinity and the strength and stiffness of the rPET compounds was observed. The rPET/PMDA printed samples which had the highest crystallinity of 14.3% recorded the highest tensile strength, tensile modulus, and flexural strength.

When the impact modifiers were added with the chain extender (rPET/IMs samples), a slight decrease in elastic modulus and tensile strength was observed. The reduction of stiffness could be attributed to the chemical interaction between the PET chain and the glycidyl methacrylate group of the reactive impact modifier (Lotader AX 8900). On the other hand, a substantial increase in the ductility measured by % elongation was noted. This was the anticipated impact of dispersing a soft rubbery phase within the rPET matrix to improve the impact strength, indicating that a high fraction of the reactive IM could be grafted into the rPET matrix, and uniform dispersion was achieved, as is shown in the SEM micrographs.

Fracture Analysis: Even though the reported values of the mechanical properties of printed rPET were lower than the properties of the injection molded samples, these properties can be improved substantially if the following recommendations are implemented: a raster angle of 0° is used, the printing speed is reduced to 30-40 mm/s, and the printing bed temperature is raised well above the T_{g}.

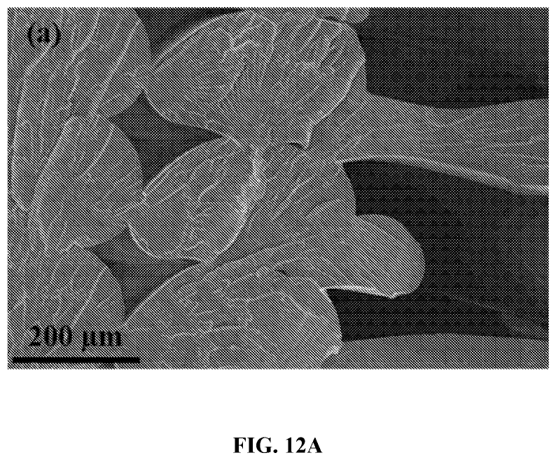

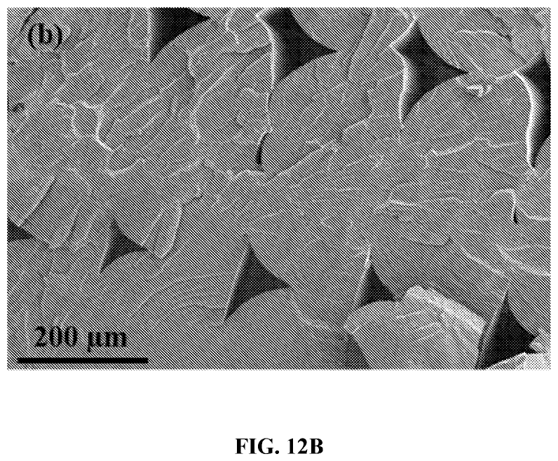

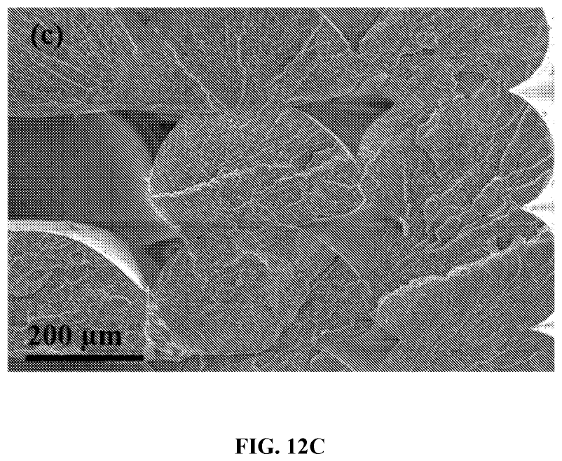

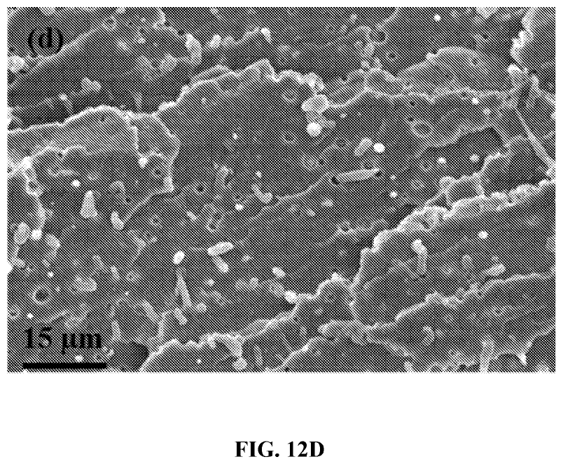

FIGS. 12A through 12C displays electron micrographs of the fractured surfaces for rPET, rPET/PMDA, and rPET/IMs 3D printed tensile samples, respectively. A fractography analysis of the fractured tensile surfaces was conducted to identify the failure mechanisms for the 3D printed rPET variants. The failure types for the rPET and rPET/PMDA from tensile samples display characteristics that indicate the failure mode was brittle, failing suddenly with relatively small amounts of deformation. The failure type of the rPET/IMs indicated mixed brittle/ductile fracture depending on weather the fracture occurs in the elastomeric phase (ductile) or the rPET matrix (brittle). FIGS. 12A through 12C highlights some of the brittle fracture characteristics in polymers such as mist, mirror and hackle, which led to cracks branching. These failures undergo progressive crack propagation in the bulk material direction. Moreover, fracture surfaces displayed in FIGS. 12A through 12C are almost flat and do not present areas of significant plastic deformation. The images show almost no reduction of cross-sectional area in deposited feedstock with no apparent existence of fibrils except for rPET/IMs samples.

The most noticeable morphological difference in these fractograms is the impact modifiers, which can be observed as small fibers in the rPET/IMs samples cross-section, FIGS. 12C and 12D. As observed in FIG. 12D, the impact modifiers are uniformly dispersed in the filament, verifying the parameters selected for filament extrusion produce a homogenous material. Additionally, when the rPET/IMs material fails, the IMs undergo additional deformation, ultimately tearing and resulting in a pull-out effect on either end of the sample, producing cavities on the fractured surface. The mechanical response of the rPET/IMs samples confirms this behavior (see FIG. 8). The stress-strain curves show a sudden decrease in stress around 35 MPa followed by substantial elongation.

It is also worth noting that the existence of voids between deposited layers (inter-bead void) may be present and may be inherent to the material extrusion printing (MEX-AM) process. However, no intera-bead voids exist, suggesting the rPET filaments are homogenous with little to no internal defects.

Overall, this example focused on extrusion of compounded rPET pellets with a chain extender and impact modifiers into filament for MEX-AM technology to embrace the concept of circular economy and sustainable material. Being able to customize the mechanical properties with the utilization of low-cost additives without negatively affecting the thermal degradation or requiring more processing steps is advantageous.

The results showed that the melt flow index has been improved by adding the chain extender and the impact modifiers, increasing the melt strength during the multiple extrusion cycles. Additionally, the mechanical properties are improved; this includes stiffness, tensile strength, impact energy, and flexural strength. The thermal behavior has not been affected. The fracture analysis of the printed samples showed brittle fracture mode, which attributed to the printing process but not the filaments.

Example 2. This example investigates the effect of the graphite powder and other additives on the extrusion, thermal behavior, and mechanical properties of a rPET extrudable 3D printing filament.

### Materials

The following additives were acquired for compounding with rPET: (1) graphite powder (SIGRATHERM-GFG 20, outsourced from sgl carbon), (2) Pyromellitic dianhydride (PMDA), a chain extender (Sigma Aldrich), and (3) Styrene-ethylene-butylene-styrene terpolymer functionalized with maleic anhydride (SEBS-g-MA), a thermal modifier and toughening agent (FG1901X, KRATON Polymers)

The compounded rPET blend consists of rPET matrix, 10 wt % graphite powder, 0.3 wt % PMDA, and 5.0 wt % SEBS-g-MA. The rPET pellets were dried at 120° C. for 12 hours in a vacuum dryer (Macguire). The three other additives (PMDA, SEBS-g-MA, and graphite powder) were dried in separate vacuum dryers (Thermo Precision Scientific) for four hours at 50° C. and kept in a vacuum dryer until extrusion.

The dried rPET pellets and additives were bag-mixed; then, the compounded rPET blend was starve-fed using a volumetric feeder into the hopper of the twin-screw extruder (see FIG. 13A). The throughput of the volumetric feeder was 10.4 kg/hr. The speed of the screws was set at 150±3 rpm throughout all extrusion processes. The extruder has eight individually-controlled temperature zones. The zone temperatures are listed in Table 4.

TABLE 4
Temperatures of the Eight Extrusion
Zones of the Compounded rPET

| | Zone Temperatures (° C.) | | | | | | | |
|---|---|---|---|---|---|---|---|---|
| Compound | 1 | 2 | 3 | 4 | 5 | 6 | 7 | 8 |
| rPET/Additives | 220 | 230 | 250 | 260 | 260 | 275 | 280 | 280 |

The ASTM standards' specimens for tests were printed. The filaments were dried at a temperature of 65° C. for 2-3 hours before printing. The filament was then stored in a dehumidifier to mitigate the hygroscopicity of rPET. The Ultimaker Cura 5.0 slicing software was used to generate the process parameters for an Ender 5 Pro 3D Printer (CREALITY). The ironing feature was activated, and no support has been used. The printing parameters are tabulated in Table 5.

TABLE 5
Material Extrusion-based Additive Manufacturing Parameters

| Nozzle Temperature | 260 | °C | Printing Bed | 90 | °C |
|---|---|---|---|---|---|
| | | | Temperature | | |
| Infill Density | 100% | | Infill Pattern | Rectilinear/Lines | |
| Printing Speed | 35-50 | mm/s | Wall Thickness | 1 | mm |
| Raster Angle | 45/−45° | | Nozzle Type | 0.4 mm Hardened | |
| | | | | Steel | |
| Layer Thickness | 0.2 | mm | Top/Bottom | 0.8 | mm |
| | | | Thickness | | |

Rheological, thermal, mechanical, and morphological characterizations were carried out to analyze the additives' effect on the behavior of the filaments and printed parts.

### Results

Rheological Behavior: Results indicate that additives may improve the melt flow index (MFI) of rPET in general. An average melt flow index of 19.6 g/10 min was obtained, which was the lowest among all recipes.

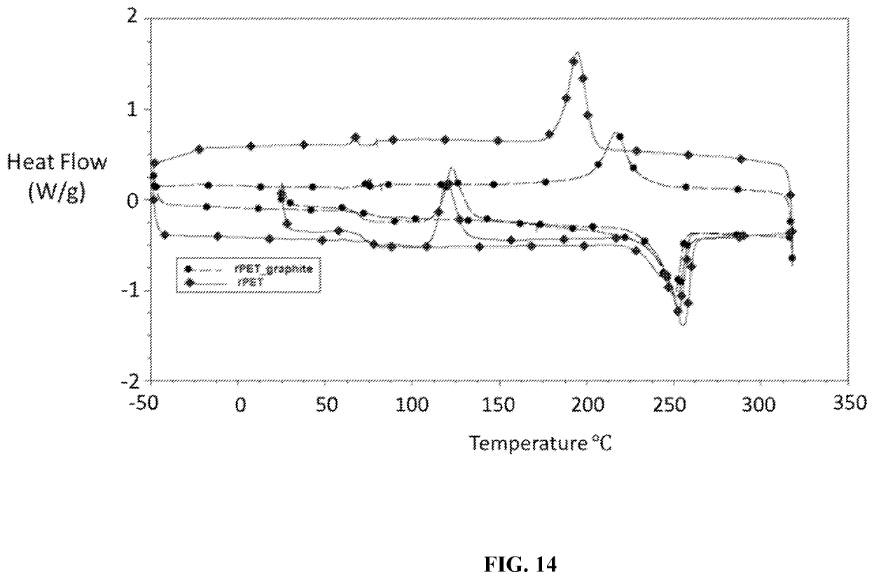

Thermal Analysis: The heating and cooling curves are depicted in FIG. 14. The first heating cycle shows the recrystallization temperature/peak of the amorphous part and the melting temperature. The addition of the graphite powder may increase the recrystallization temperature and decrease the melting temperature. The second heating cycle shows the glass transition temperature, which indicates a slight decrease in the rPET/graphite sample. The cooling cycle shows a pronounced increase in the crystallization temperature of the PET/graphite sample.

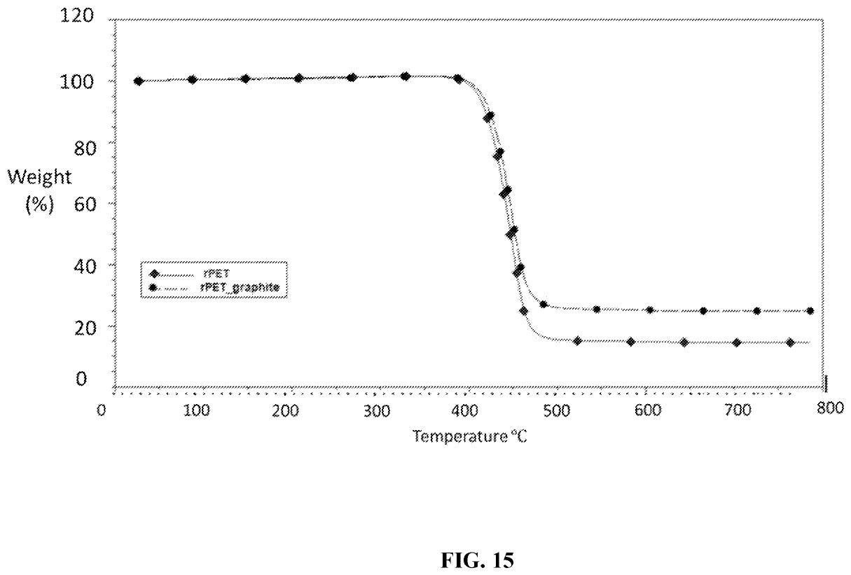

As seen in FIG. 15, the TGA graph shows that the addition of the graphite powder slightly shifted the degradation temperature to a higher temperature and maintained a single degradation peak, which proves the homogeneity of the compounded rPET/graphite and the uniform distribution of the additives within the matrix.

Mechanical Properties: The tensile strength reached 49 MPa, the tensile modulus increased to about 3.2 GPa, and the strain % at break decreased to 2.4% compared to plain rPET. Moreover, IZOD impact samples were tested according to the ASTM D256. Results showed that IZOD impact energy increases to 2.8 KJ/m².

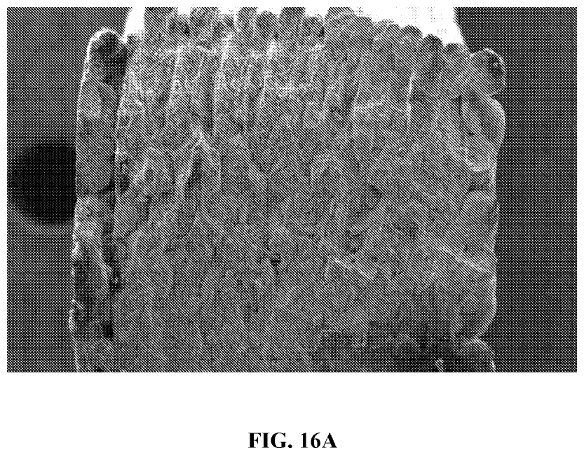

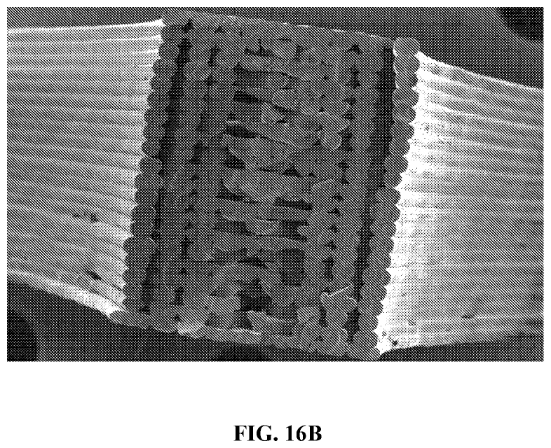

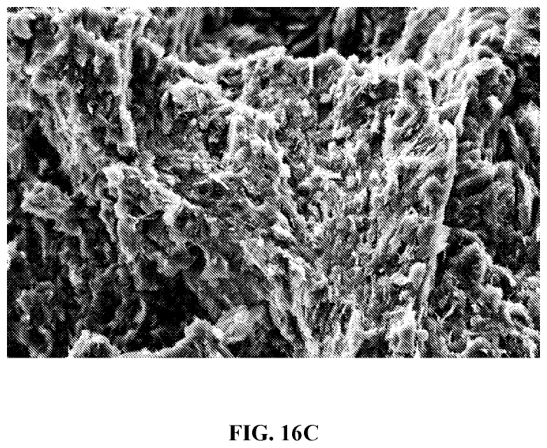

Fracture Analysis: FIGS. 16A-16C display improved fusion between the layers and the increase in the ductility of the fractured surfaces, which agrees with the high IZOD impact energy recorded.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the apparatus and process for extrudable filament formation and/or utilization and methods of making and using the same have been discussed and illustrated herein, it is to be distinctly understood that the invention is not limited thereto but may be otherwise variously embodied and practiced within the scope of the following claims.

1. An extrudable filament, comprising:
recycled polyethylene terephthalate and additives, wherein the additives comprise:
at least one chain extender;
at least one toughening agent;
at least one reactive impact modifier; and
at least one non-reactive impact modifier.

2. The extrudable filament of claim 1, wherein the filament has a diameter of 1.7-1.8 mm.

3. The extrudable filament of claim 1, wherein the at least one chain extender is selected from the group consisting of pyromellitic dianhydride, trimellitic anhydride, triphenyl phosphite, multi-functionalized epoxy, and mixtures thereof.

4. The extrudable filament of claim 1, wherein the at least one chain extender is pyromellitic dianhydride.

5. The extrudable filament of claim 1, wherein the at least one toughening agent is selected from the group consisting of styrene-ethylene-butylene-styrene terpolymer functionalized with maleic anhydride, polyethylene octene, polyethylene octene grafted with glycidyl methacrylate, and mixtures thereof.

6. The extrudable filament of claim 1, wherein the at least one toughening agent is styrene-ethylene-butylene-styrene terpolymer functionalized with maleic anhydride.

7. The extrudable filament of claim 1, wherein the at least one reactive impact modifier is ethylene-ethyl acrylate-glycidyl methacrylate terpolymer or ethylene-vinyl acetate copolymer functionalized with maleic anhydride.

8. The extrudable filament of claim 1, wherein the at least one non-reactive impact modifier is selected from the group consisting of ethylene-ethyl-acrylate, ethylene-butyl acrylate, ethylene-methyl acrylate, polymethyl methacrylate-g-polybutadiene/styrene graft copolymer, and mixtures thereof.

9. The extrudable filament of claim 1, wherein the at least one non-reactive impact modifier is ethylene-ethyl-acrylate.

10. The extrudable filament of claim 1, wherein the weight ratio of reactive to non-reactive impact modifier is 30:70.

11. The extrudable filament of claim 1, wherein the filament has a melting temperature of 250-255° C. and/or
the filament has a degradation onset temperature of 390-410° C.

12. (canceled)

13. A 3D-printed part made from the extrudable filament of claim 1.

14. The 3D-printed part of claim 13, wherein at least one of the following properties are met:
the printed part has an elongation percentage ranging from 6% to 100%,
the printed part has a tensile strength ranging from 35 MPa to 48 MPa,
the printed part has a flexural strength ranging from 35 MPa to 46 MPa,
the printed part has a 30% flexural strain at break, and/or
the printed part has an impact energy of about 2.5 KJ/m².

15-18. (canceled)

19. An extrudable filament, comprising:
recycled polyethylene terephthalate and additives, wherein the additives comprise:
at least one chain extender;
at least one toughening agent; and
graphite powder.

20. The extrudable filament of claim 19, wherein the additives further comprise at least one reactive impact modifier and at least one non-reactive impact modifier.

21. The extrudable filament of claim 19, wherein the graphite powder is present in an amount between 5-15 wt % of the filament.

22. A method of forming the extrudable filament of claim 1, comprising:
drying the recycled polyethylene terephthalate and additives;
mixing the recycled polyethylene terephthalate and additives to form a compounded blend;
extruding the compounded blend to form an extruded filament; and
cooling the filament.

23. The method of claim 22, wherein the cooling of the filament comprises air cooling or water cooling.

24. An extrudable filament, comprising:
recycled polyethylene terephthalate and additives, wherein the additives comprise:
at least one chain extender;
at least one toughening agent;
at least one reactive impact modifier; and
at least one non-reactive impact modifier;
wherein the at least one chain extender includes pyromellitic dianhydride, trimellitic anhydride, triphenyl phosphite, multi-functionalized epoxy, and/or mixtures thereof;
wherein the at least one toughening agent includes styrene-ethylene-butylene-styrene terpolymer functionalized with maleic anhydride, polyethylene octene, polyethylene octene grafted with glycidyl methacrylate, or mixtures thereof;
wherein the at least one reactive impact modifier includes ethylene-ethyl acrylate-glycidyl methacrylate terpolymer or ethylene-vinyl acetate copolymer functionalized with maleic anhydride;
wherein the at least one non-reactive impact modifier includes ethylene-ethyl-acrylate, ethylene-butyl acrylate, ethylene-methyl acrylate, polymethyl methacrylate-g-polybutadiene/styrene graft copolymer, or mixtures thereof,
wherein the weight ratio of the at least one reactive impact modifier to the at least one non-reactive impact modifier is 30:70.

25. The extrudable filament of claim 24, wherein the filament has a diameter of 1.7-1.8 mm.
